(19) United States
(12) Patent Application Publication
(10) Pub. No.: US 2018/0183265 A1
(43) Pub. Date: Jun. 28, 2018

(54) SUPPORT TRAY WITH DEVICE CHARGING

(71) Applicants: Norman R. Byrne, Ada, MI (US); Peter Stathis, San Francisco, CA (US)

(72) Inventors: Norman R. Byrne, Ada, MI (US); Peter Stathis, San Francisco, CA (US)

(21) Appl. No.: 15/853,731

(22) Filed: Dec. 23, 2017

Related U.S. Application Data
(60) Provisional application No. 62/438,904, filed on Dec. 23, 2016.

(51) Int. Cl. H02J 50/10; H02J 7/00; H02J 7/02

(52) U.S. Cl. CPC H02J 50/10; H02J 7/0044; H02J 7/025; H02J 7/0027

(57) ABSTRACT

A support tray with electrical charging capability facilitates the use and recharging of portable electronic devices having onboard batteries or the like. The support tray includes a tray body, a device support, an electrical power receiver, and an electrical power output device. The tray body has an upper surface for supporting a portable electronic device, and the device support is configured to support the portable electronic device in an upright orientation relative to the upper surface of the tray body. The electrical power receiver receives electrical power from an outside power source, such as a wall outlet, and the electrical power output device is a wireless power transmitter, a high voltage AC power receptacle, a low voltage DC power receptacle, or a combination thereof.

### CROSS REFERENCE TO RELATED APPLICATION

The present application claims the benefit of U.S. provisional application Ser. No. 62/438,904, filed Dec. 23, 2016, which is hereby incorporated herein by reference in its entirety.

### FIELD OF THE INVENTION

The present invention relates to supports for portable electronic devices.

### BACKGROUND OF THE INVENTION

Portable electronic devices often require charging of their onboard batteries, capacitors, or other electrical energy storage devices. However, in many circumstances the locations where compatible electrical power sources are available for charging purposes are not conducive to permitting usage of the portable electronic devices while the devices are charging. It may also be inconvenient for persons to move all of their essential work tools, including electronic devices, from one place to another.

### SUMMARY OF THE INVENTION

The present invention provides a support tray with electrical charging capability for portable electronic devices such as laptop computers, smart phones, tablet computers, media players, and the like, which require occasional recharging of their onboard batteries or other electrical energy storage devices. The support tray of the present invention is capable of recharging at least one portable electronic device that is being supported on the tray, and may do so in a completely wireless manner or with wired connection(s) to an outside power source, and/or between the tray and the portable electronic device. In some embodiments, the support tray is capable of supporting one or more portable electronic devices in an upright orientation, such as to facilitate viewing of a device screen and using touch screen controls of the device.

The support tray allows users to conveniently move essential work tools and electrical power with them to substantially any area or location where they may care to work or accomplish other tasks. Such locations may include office or study areas with open tables or desks, hotel rooms and lobbies, substantially any room of a dwelling place, automobiles and other transit vehicles, and the like. In some cases the support tray may be used as a substitute for a work desk or table, or may be used in conjunction with or on top of a work desk or table, or the like.

In one form of the present invention, a portable support tray with electrical charging capability includes a rigid tray body, a device support for supporting a portable electronic device at the tray body, an electrical power receiver at the tray body, and at least one electrical power output device coupled to the tray body. The tray body has an upper surface configured to support a first portable electronic device, and the device support is configured to support a second portable electronic device in an upright orientation, with a display screen of the second portable electronic device set at an oblique angle relative to the upper surface of the tray body. The electrical power receiver is configured to receive electrical power from an outside power source, such as a wall outlet or a floor outlet connected to the electrical mains of a building or transit vehicle. The electrical power output device includes any one or more of a wireless power transmitter, a high voltage AC power receptacle, and a low voltage DC power receptacle. The electrical power output device is operable to supply electrical power to the first and second portable electronic devices simultaneously.

According to one aspect, the device support is an elongate well formed in the upper surface of the tray body.

According to another aspect, the at least one electrical power output device includes a first wireless power transmitter at the elongate well, and the first wireless power transmitter is operable to wirelessly charge a battery of the second portable electronic device when a portion of the second portable electronic device is received in the elongate well.

According to yet another aspect, the electrical power output device further includes a second wireless power transmitter below the upper surface and spaced laterally from the elongate well. The second wireless power transmitter is operable to wirelessly charge a battery of the second portable electronic device when a portion of the second portable electronic device is received in the elongate well.

According to still another aspect, the support tray further includes an electrical power storage device at the tray body. The electrical power storage device is configured to receive electrical power from the outside power source and to convey stored electrical power to the one or more electrical power output devices. Optionally, the one or more electrical power output devices include at least one low voltage DC power outlet positioned along the upper surface.

According to a further aspect, the one or more electrical power output devices further include a wireless power transmitter disposed in the tray body. Optionally, a wireless power receiver is disposed in the tray body below the wireless power transmitter, and is configured to wirelessly receive electrical power from a wireless power transmitter that is electrically coupled to the outside power source.

According to a still further aspect, the tray body includes a pair of gripping regions arranged on opposite sides of the tray body. Optionally, the gripping regions are formed as elongate openings formed in the tray body.

According to another aspect, a support pad is positioned along a lower surface of the tray body, and is made of a soft resilient material.

Accordingly, the portable support tray of the present invention provides a convenient and portable working space where a user can rest a portable electronic device such as a laptop computer, a smart phone, a tablet computer, or a camera, or combinations of those, and can operate the portable electronic device(s) while also charging their onboard batteries. The charging power may come directly from electrical mains, such as a plug-in connection, or may come from a rechargeable battery, capacitor, or other energy storage device mounted at the support tray, which would allow the support tray to be moved to different locations while supporting and supplying uninterrupted power to the portable electronic device(s).

These and other objects, advantages, purposes and features of the present invention will become apparent upon review of the following specification in conjunction with the drawings.

### BRIEF DESCRIPTION OF THE DRAWING

FIG. 1 is a perspective view of a support tray with device charging capability, in accordance with the present invention;

FIG. 2 is a perspective view of another support tray with device charging capability, including a wireless power transmitter;

FIG. 3 is a perspective view of another support tray with device charging capability, including a wireless power transmitter, shown with a laptop computer and a smart phone supported on the tray and receiving wireless charging power;

FIG. 4 is a perspective view of another support tray with device charging capability, including high voltage and low voltage electrical outlets;

FIG. 5 is another perspective view of the support tray of FIG. 4, shown with a laptop computer and a smart phone supported on the tray and each receiving power from a respective receptacle;

FIG. 6 is a perspective view of another support tray with device charging capability, including an onboard rechargeable power source, a wireless power receiver and transmitter, portable device wells, and low voltage electrical outlets, with the support tray shown in phantom;

FIG. 7 is another perspective view of the support tray of FIG. 6, shown positioned atop a wireless power transmitter for recharging the onboard power source;

FIG. 8 is another perspective view of the support tray of FIG. 6, with shown with a tablet computer and a smart phone supported on the tray and each receiving power; and

FIG. 9 is another perspective view of the support tray of FIG. 6, shown with a laptop computer and a smart phone supported on the tray and each receiving power.

### DESCRIPTION OF THE PREFERRED EMBODIMENTS

Referring now to the drawings and the illustrative embodiments depicted therein, a support tray 10 provides electrical charging capability for portable electronic devices such as laptop computers 12, smart phones 14, tablet computers 16, media players, cameras, and substantially any other portable electronic device having an onboard rechargeable battery, capacitor, or other electrical energy storage device. As will be described in more detail below, various support trays 10, 110, 210, 310, 410 may be configured for supporting different types of portable electronic devices, sometimes in different orientations, and adapted to convey electrical power to those devices using direct-contact electrical receptacles 18a, 18b and/or with wireless power transmitters or combination wireless power transmitter/receiver combinations 20.

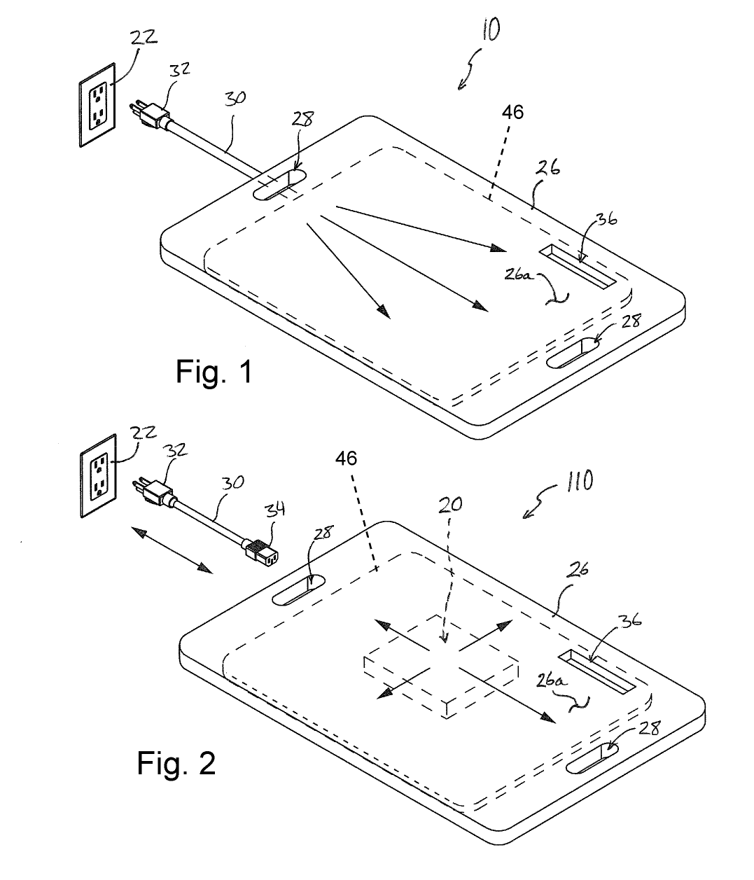

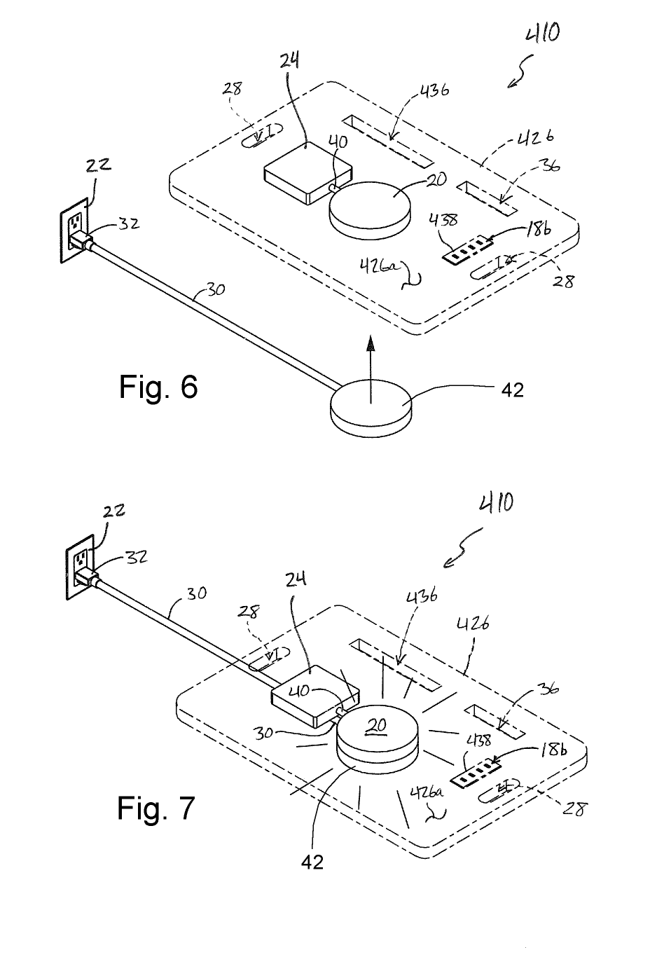

The support trays 10, 110, 210, 310, 410 may be supplied with electrical power received from a mains source, such as a conventional wall outlet 22 (FIGS. 1, 2 and 6-9), and optionally may include an onboard rechargeable electrical energy storage device such as a battery or capacitor 24, such as shown in FIGS. 6-9. The support trays permit a user to move one or more portable electronic devices, in some cases without interrupting their charging cycles, and facilitate the viewing and use of those devices even while they are being charged. The support trays may be positioned along a user's lap, on a tray table in a transit vehicle, or on a desk or table or other work surface.

In its most basic form, support tray 10 is made from a substantially planar tray body 26 with a pair of elongate openings 28 formed or established at its opposite ends (FIGS. 1 and 2) to provide secure gripping areas to facilitate a user lifting or repositioning the tray. Planar tray body 26 is preferably made of a substantially rigid material so that support tray 10 can be gripped at opposite edges (such as gripping areas at elongate openings 28) and lifted and moved to another area, even with one or more articles supported on the tray body 26. For example, the planar tray body 26 may be made from any suitable metal or non-metal, including but not necessarily limited to resinous plastics, composites or laminated materials, metals, ceramics, wood, or combinations of those.

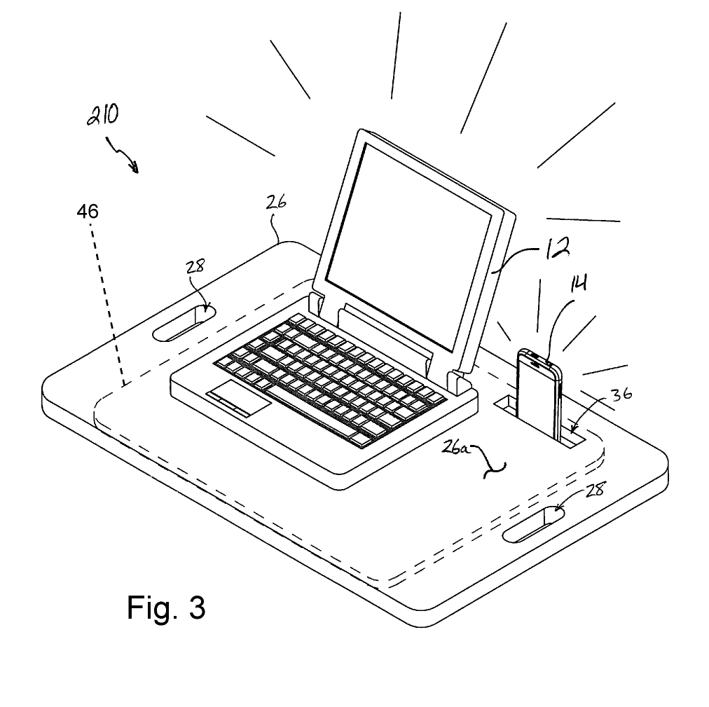

An electrical power cord 30 includes a male plug 32 for engaging wall outlet 22, and a female receptacle 34 opposite the plug 32 and configured to engage male prongs of an electrical connector (not shown) that is positioned along a lower surface or perimeter edge of tray body 26. Electrical power received from wall outlet 22 is then conveyed to one or more locations along tray body 26, such as direct-contact electrical receptacles (not shown in FIGS. 1 and 2) or a wireless power transmitter 20, such as shown in the support tray 110 of FIG. 2. Optionally, an elongate well or recess 36 is formed in an upper surface 26a of body 26, and is configured to receive an edge portion of a portable electronic device, such as smart phone 14 or tablet computer 16, and to support the device in an upright orientation with the device's display screen set at an oblique angle relative to the support tray's top surface 26a, such as shown in connection with support tray 210 of FIG. 3. It will be appreciated that support trays 10, 110, 210 may be identical or substantially identical to one another, differing (if at all) only in the manner in which they convey electrical power to portable electronic devices positioned thereon.

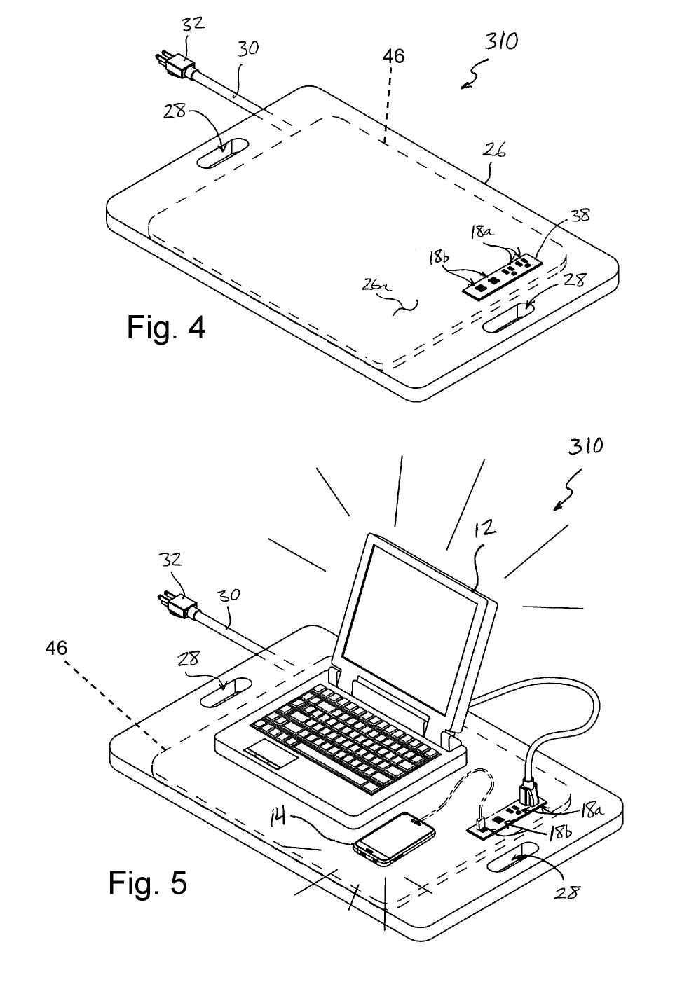

Optionally, a support tray 310 is provided with both high voltage AC power outlets 18a and low voltage DC power outlets 18b along a power block 38 that is recessed into upper surface 26a of tray body 26, such as shown in FIGS. 4 and 5. AC power outlets 18a may receive power directly from power cord 30, such as 110V or 220V AC power. Low voltage DC power outlets 18b are supplied with low voltage DC power, such as 2V to 18V DC, via an electrical power converter (not shown) that is disposed in power block 38 or elsewhere along the tray body 26. The electrical power converter converts the high voltage AC power received from power cord 30 to the low voltage power that is suitable for low voltage DC power outlets 18b. However, it is also envisioned that low voltage DC power outlets 18b could be supplied with low voltage DC power via dedicated low voltage conductors leading to a separate low voltage power source. Low voltage DC power outlets 18b may be USB-style power-only or power-and-data outlets (such as USB-A or USB-C), or substantially any other type of low voltage electrical outlets. It is further envisioned that support tray 310 could be equipped with electronic data outlets, if desired. As shown in FIG. 5, support tray 310 can simultaneously support and recharge laptop computer 12 via one of the high voltage AC power outlets 18a, support and recharge smart phone 14 via one of the low voltage DC power outlets 18b, and could further support and supply charging power to at least two other portable electronic devices via open outlets 18a, 18b.

As noted above, it is further envisioned that a wireless support tray 410 may be provided with rechargeable battery or capacitor 24 or other energy storage device mounted to an interior or a lower surface of the tray body 426, such as shown in FIGS. 6-9. Wireless power transmitter and receiver 20 is in electrical communication with battery or capacitor 24 via a power cord 40, with the wireless power transmitter and receiver 20 including a wireless power receiver at its lower end and a wireless power transmitter at its upper end, or a single transceiver capable of operating in either a receiver mode or a transmitter mode. With wireless power transmitter and receiver 20 ready for receiving power from an outside source, tray body 426 may be lowered and aligned relative to a wireless power transmitter 42 that is electrically energized by the power cord 30 that is coupled to wall outlet 22. This enables battery or capacitor 24 to be recharged as long as the transmitter and receiver 20 is within range of an energized power transmitter 42.

It is further envisioned that the wireless power device 20 mounted in the support tray may be a receiver-only or transmitter-only device, rather than providing both wireless transmitting and receiving capability. Wireless power transmission technologies utilized may include magnetic resonance field induction, electric field resonant capacitive coupling, or direct-contact pads with “lanes” of electrical conductors having opposite polarities, for example.

With battery or capacitor 24 in a charged state, it is capable of electrically energizing the transmitter or transmitter portion of wireless power transmitter and receiver 20, and may also energize one or more direct-contact electrical receptacles such as low voltage DC power outlets 18b in a power block 438 that is embedded in an upper surface 426a of tray body 426 (FIGS. 6-9). Wireless power transmitter and receiver 20 directs electrical power upwardly through upper surface 426a, which is typically a nonmetallic material such as wood, resinous plastic, ceramic, or composite material, or a combination of materials. It may be advantageous to construct a significant portion of the support tray body 26 of metal or some other material that is not suitable for wireless electrical power transmission, while using a more suitable non-metal as the material that forms upper surface 426a, or at least a region of upper surface 426a that is directly above a wireless power transmitter. Likewise, a non-metal would typically be used in at least a region of a lower surface of the support tray body 26 that is directly below a wireless power receiver, if so equipped.

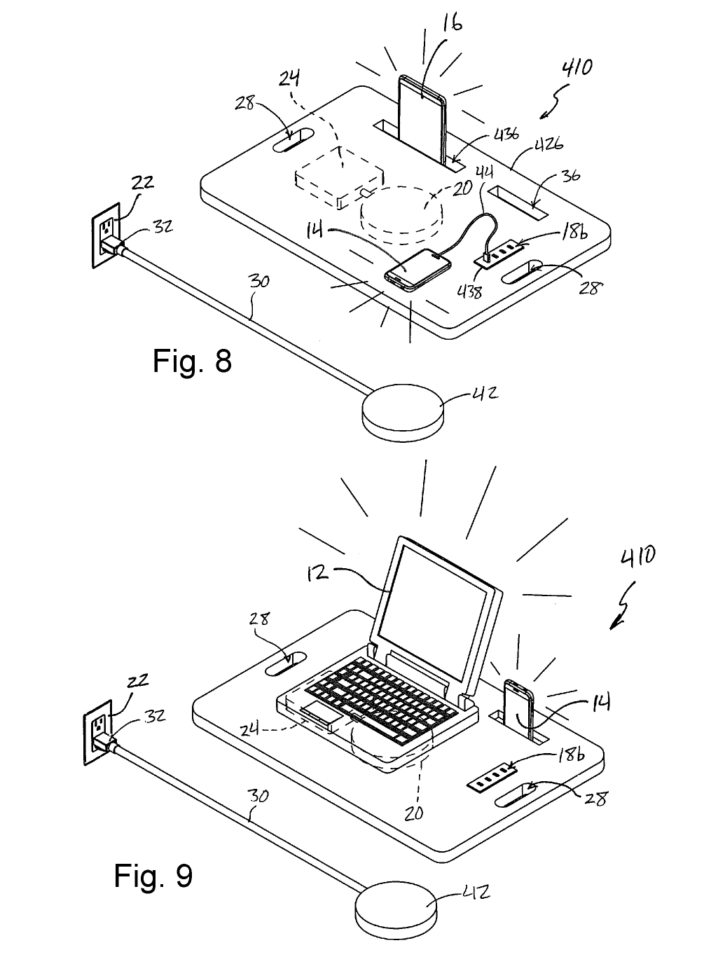

The wireless power is received by a wireless power receiver antenna or resonator located in a lower surface of a compatible electronic device such as laptop computer 12. In addition to a first elongate well or recess 36 for supporting a smart phone 14 or similarly-sized device, a second elongate well or recess 436 is provided in upper surface 426a for supporting a larger portable electronic device, such as tablet computer 16 (FIG. 8). Each of the wells 36, 436 may be equipped with their own wireless power transmitters or direct-contact electrical connectors (not shown), for energizing compatible electronic devices that are supported in the wells. It will be appreciated that in addition to wells 36, 436, other device supports such as upstanding rails or other supports may be provided, which are also capable of supporting portable electronic devices in an upright orientation along the tray bodies. The optional DC power outlets 18b of power block 438 also permit the charging of various devices via low voltage power and/or data cords 44 (FIG. 8).

Optionally, and with reference to FIGS. 1-5, a support pad 46 may be provided along a lower surface of the tray body 26. Support pad 46 may be made of a soft resilient material, such as foam rubber, or foam-like or rubber-like materials, loose cotton or synthetic fibrous filler material, and may increase comfort when a support tray is rested on a user's lap, including by providing thermal insulation. Optionally, thermal vents may be provided through the tray body 26 and/or support pad 46. Support pad 46 may also have a higher friction coefficient than the lower surface of the tray body 26, to reduce the likelihood of inadvertent sliding of the support tray 10 on other surfaces. Although support tray 10 and support page 46 are illustrated as generally rectangular and planar bodies, it will be appreciated that other shapes are envisioned, including non-planar surfaces such as for contouring to rest on a user's lap.

Therefore, the portable support tray, in either corded or cordless form, provides a portable working space for simultaneously supporting and charging portable electronic devices, while also permitting the devices to be positioned in convenient locations for use and viewing. Cordless embodiments of the support tray, with onboard battery or other electrical energy storage capability, can be moved to different locations while supplying uninterrupted power to the portable electronic device(s) positioned thereon.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A portable support tray with electrical charging capability comprises:
a rigid tray body having an upper surface configured to support a first portable electronic device;
a device support at said tray body, wherein said device support is configured to support a second portable electronic device in an upright orientation with a display screen of the second portable electronic device set at an oblique angle relative to said upper surface of said tray body;
an electrical power receiver at said tray body, said electrical power receiver configured to receive electrical power from an outside power source; and
at least one electrical power output device coupled to said tray body, said electrical power output device comprising at least one chosen from a wireless power transmitter, a high voltage AC power receptacle, and a low voltage DC power receptacle;
wherein said at least one electrical power output device is operable to supply electrical power to the first and second portable electronic devices simultaneously.

2. The support tray of claim 1, wherein said device support comprises an elongate well formed in said upper surface of said tray body.

3. The support tray of claim 2, wherein said at least one electrical power output device comprises a first wireless power transmitter at said elongate well, wherein said first wireless power transmitter is operable to wirelessly charge a battery of the second portable electronic device when a portion of the second portable electronic device is received in said elongate well.

4. The support tray of claim 3, wherein said at least one electrical power output device further comprises a second wireless power transmitter below said upper surface and spaced laterally from said elongate well, wherein said second wireless power transmitter is operable to wirelessly charge a battery of the second portable electronic device when a portion of the second portable electronic device is received in said elongate well.

5. The support tray of claim 1, further comprising an electrical power storage device at said tray body, wherein said electrical power storage device is configured to receive electrical power from the outside power source and to convey stored electrical power to said at least one electrical power output device.

6. The support tray of claim 5, wherein said at least one electrical power output device comprises at least one low voltage DC power outlet positioned along said upper surface.

7. The support tray of claim 6, wherein said at least one electrical power output device further comprises a wireless power transmitter disposed in said tray body.

8. The support tray of claim 7, further comprising a wireless power receiver disposed in said tray body below said wireless power transmitter, wherein said wireless power receiver is configured to wirelessly receive electrical power from a wireless power transmitter that is electrically coupled to the outside power source.

9. The support tray of claim 1, wherein said tray body comprises a pair of gripping regions arranged on opposite sides of said tray body.

10. The support tray of claim 9, wherein said gripping regions comprise elongate openings formed in said tray body.

11. The support tray of claim 9, further comprising a support pad positioned along a lower surface of said tray body, wherein said support pad comprises a soft resilient material.

12. A portable support tray with electrical charging capability comprises:
a rigid tray body having an upper surface configured to support a first portable electronic device;
a device support formed in said tray body, wherein said device support is configured to support a second portable electronic device in an upright orientation with a display screen of the second portable electronic device set at an oblique angle relative to said upper surface of said tray body;
an electrical power receiver at said tray body, said electrical power receiver configured to receive electrical power from an outside power source; and
a wireless power transmitter coupled to said tray body and positioned below said upper surface, wherein said wireless power transmitter is configured to electrically energize the first portable electronic device at said upper surface; and
a low voltage DC power receptacle coupled to said tray body, wherein said second electrical power output device is configured to electrically energize the second portable electronic device via a charging cord.

13. The support tray of claim 12, wherein said device support comprises an elongate well formed in said upper surface of said tray body, and wherein said elongate well is configured to receive an edge portion of the second portable electronic device.

14. The support tray of claim 13, further comprising an electrical power storage device at said tray body, wherein said electrical power storage device is configured to receive electrical power from the outside power source and to convey stored electrical power to said wireless power transmitter and to said low voltage DC power receptacle.

15. The support tray of claim 14, further comprising a wireless power receiver disposed in said tray body below said wireless power transmitter, wherein said wireless power receiver is configured to wirelessly receive electrical power from a wireless power transmitter that is electrically coupled to the outside power source.

16. The support tray of claim 15, wherein said tray body comprises a pair of gripping regions arranged on opposite sides of said tray body.

17. The support tray of claim 16, wherein said gripping regions comprise elongate openings formed in said tray body.

18. The support tray of claim 17, further comprising a support pad positioned along a lower surface of said tray body, wherein said support pad comprises a soft resilient material.
